(19) United States
(12) Patent Application Publication
(10) Pub. No.: US 2007/0108678 A1
(43) Pub. Date: May 17, 2007

(54) PROCESS FOR MANUFACTURING A HYDRAULIC BEARING AS WELL AS A HYDRAULIC BEARING MANUFACTURED ACCORDING TO THE PROCESS

(76) Inventors: Toralf Huettner, Osnabrueck (DE); Hubert Siemer, Dinklage (DE); Stefan Loheide, Wallenhorst (DE); Thomas Mechelhoff, Dinklage (DE); Reimund Boergerding, Steinfeld (DE)

Correspondence Address: MCGLEW & TUTTLE, PC, P.O. BOX 9227, SCARBOROUGH STATION, SCARBOROUGH, NY, 10510-9227, US

(21) Appl. No.: 11/556,806

(22) Filed: Nov. 6, 2006

(30) Foreign Application Priority Data
Nov. 15, 2005 (DE) 10 2005 054 853.9

(51) Int. Cl. F16F 13/00

(52) U.S. Cl. 267/140.12

(57) ABSTRACT

A process is provided for manufacturing a hydraulic bearing having an inner part (1), an elastomeric bearing body (2), connected to the inner part (1) by vulcanization, and an outer sleeve (3). At least two damping agent chambers (4, 4′) are filled with a viscous damping agent and are connected to one another through a flow or throttle channel (44) and are sealed against the escape of the damping agent by at least two sealing lips (5, 5′). A volume (6) is arranged between the sealing lips (5, 5′) separated from the damping agent chambers (4, 4′) and from the channel connecting same. The damping agent chambers (4, 4′) are filled with the damping agent, and the outer sleeve (3) is pushed first onto the hydraulic bearing. There is a subsequent filling of the volume (6) with a viscous liquid (7), whose viscosity differs from the viscosity of the damping agent.

### CROSS REFERENCE TO RELATED APPLICATIONS

This application claims the benefit of priority under 35 U.S.C. § 119 of German Patent Application DE 10 2005 054 853.9 filed Nov. 15, 2005, the entire contents of which are incorporated herein by reference.

### FIELD OF THE INVENTION

The present invention pertains generally to hydraulic bearings and more particularly to processes for manufacturing a hydraulic bearing and hydraulic bearings made by the process.

### BACKGROUND OF THE INVENTION

Bearings designed as simple rubber bushings with an inner part, an outer sleeve or an outer tube and an elastomeric bearing body arranged between them are frequently used in the automobile industry and specifically above all in the area of the chassis suspension. Hydraulic damping methods are used to support the damping action of the elastomeric bearing body because they may mean a substantial increase in comfort. Such hydraulic bearings have at least two damping agent chambers, which are formed in the bearing body, filled with a viscous damping agent and are connected to one another in a flow-conducting manner through at least one channel Concerning the design of the bearings, it must be ensured that the viscous damping agent cannot escape, i.e., that the bearing is sealed and also remains sealed for the necessary service life. Hydraulic bearings have seals for this.

One measure, which can frequently be encountered in practice in case of elastomeric bush bearings, is, for example, to design the elastomer bearing body with an oversize compared to the outer sleeve accommodating the bearing in the area of its axial ends. A so-called calibration takes place in the course of the mounting of the bearing and when the outer tube is being pushed on by the diameter of the outer tube being reduced at least in the area of its axial ends by means of corresponding tools. A pretension, by which sealing action can be achieved, is generated hereby in the elastomeric sealing areas formed at the axial ends of the bearing body. A bearing designed in this manner is disclosed, for example, in DE 28 41 505 A1.

The latter solution has proved to be successful at least in respect to the sealing of the bearings against the escape of the viscous damping agent. However, it is also known for certain applications that hydraulic bearings can be designed such that a vacuum is present against the ambient pressure in their damping agent chambers formed in the bearing body to accommodate the viscous damping agent. There is a risk in this case that even though the damping agent will not escape from the damping agent chambers, air will penetrate into the damping agent chambers and the function of the component will be compromised as a consequence of an increase in the pressure inside the chambers. This risk arises from the fact that the viscosity of the air is markedly lower than that of the damping agent present in the damping agent chambers, so that even though the sealing action achieved by means of a sealing lip formed at the bearing may be sufficient for the damping agent, it is not sufficient for sealing against the penetration of air. Air may thus penetrate into the damping agent chambers, especially as a consequence of temperature changes.

A similar problem also arises in case of the design according to EP 1 291 549 A1. This document describes a hydraulic bearing, which comprises a cylindrical inner part, an elastomeric bearing body surrounding the inner part and an outer sleeve accommodating the inner part with the bearing body, wherein two damping agent chambers, which are filled with a viscous damping agent and are connected to one another through a flow or throttle channel, are arranged in the bearing body. The damping agent chambers are sealed against the escape of the damping agent by sealing lips formed at the axial ends of the hydraulic bearing, and a volume, which is arranged separated from the damping agent chambers and the channel connecting same, is formed between the sealing lips, and this volume is filled with a viscous liquid.

It is necessary in such a hydraulic bearing to use the same liquid in the volumes between the sealing lips and the damping agent chambers. Furthermore, this prior-art embodiment has another drawback in that air that has once penetrated into the sealing area can also enter the damping agent chambers. However, this is to be avoided by all means, because the hydraulic bearing would thus become unfit for use.

### SUMMARY OF THE INVENTION

The object of the present invention is to provide a process for manufacturing a hydraulic bearing, which is simple and inexpensive and reliably guarantees the sealing action of the finished hydraulic bearing both against the escape of damping agent from the bearing and against the penetration of air into the bearing, as well as to propose a hydraulic bearing manufactured correspondingly.

The hydraulic bearing manufactured according to the first process according to the present invention may be preferably a hydraulic, elastomeric bush bearing (the basic concepts of the design being known). The hydraulic bearing comprises an inner part, an elastomeric bearing body, which surrounds this inner part and is connected to it by vulcanization, as well as an outer sleeve accommodating the aforementioned components, i.e., the inner part with the bearing body. To achieve hydraulic damping, at least two damping agent chambers, which are filled with a viscous damping agent and are connected to one another through a throttle or flow channel, are arranged in the elastomeric bearing body. The damping agent chambers are sealed against the escape of the damping agent by sealing lips, which are present, for example, on the axial front sides of the hydraulic bearing designed as a bush bearing. These sealing lips are preferably embodied by areas of the elastomeric bearing body that have an enlarged outside diameter compared to the inside diameter of the outer sleeve. During mounting or when the outer sleeve is pushed on the bearing body, a pretension is generated thereby in the elastomer in the areas with oversize. Reliable sealing against the escape of damping agent is formed as a result because of the viscosity of the damping agent. It shall be emphasized that the volume formed between the sealing lips is not connected to the damping agent chambers in a flow-conducting manner and is consequently a volume arranged separated from the damping agent chambers and from the channel connecting same.

After the inner part with the elastomeric bearing body vulcanized to it as well as the outer sleeve have been prefabricated, the damping agent chambers are first filled with the damping agent. For the subsequent filling of the volume with a viscous liquid, whose viscosity differs from the viscosity of the damping agent, the outer sleeve is pushed onto the elastomeric bearing body first only up to the axially inner sealing lip, i.e., the sealing lip facing the damping agent chamber. After the volume has been filled with the viscous liquid, the outer sleeve is pushed completely over the elastomeric bearing body, so that it will now accommodate this bearing body and also sealingly contacts the axially outermost sealing lip, i.e., the sealing lip located farthest away from the damping agent chamber. The sealing lips form a kind of viscoseal together with the volume of a viscous liquid, which volume is enclosed by them.

The pressure in the viscoseals should correspond essentially to the ambient pressure or be higher than this. However, it is, moreover, also possible to consider the fact that even though the bearing is manufactured with a pressure that is slightly increased compared to the ambient pressure in the volumes of the viscoseals, this pressure is temporarily nevertheless lower under extreme ambient conditions, with extreme outside pressure conditions, than the currently prevailing ambient pressure. The pressure in the viscoseals therefore corresponds at least essentially to the ambient pressure, i.e., it is approximately equal to this or is possibly (albeit only briefly) lower than this.

It is theoretically conceivable that ambient air will penetrate to a low extent into the viscoseals formed by the volumes under extreme conditions. However, this air cannot break through to the damping agent chambers if the liquid used in the viscoseals has a viscosity that is different from the viscosity of the damping agent.

Different viscosities can be defined both as a viscosity of the damping agent that is higher than the viscosity of the liquid in the volumes and as the preferred opposite case that the viscosity of the liquid is higher than that of the damping agent.

Furthermore, it should be noted that the liquid used in the viscoseals may also possess pasty properties or it may be a curing liquid, which still possesses elastic properties after curing. The term “liquid” shall not therefore be interpreted narrowly in the sense of the present invention.

An injection method may, furthermore, be used to fill the at least one volume between the sealing lips with the viscous liquid. At least one filling opening is to be provided for this either in the elastomeric bearing body or in the outer sleeve. After the inner part with the elastomeric bearing body vulcanized to it as well as the outer sleeve have been prefabricated, the damping agent chambers are first filled with the damping agent. Corresponding to the alternative processes presented here for manufacturing a hydraulic bushing, the outer sleeve is pushed onto the hydraulic bushing for the subsequent filling of the at least one volume in order to subsequently enable the volume or the volumes to be filled with the viscous liquid through the respective filling opening. An injection nozzle may be used for filling.

A preferred manufacture of a hydraulic bearing according to the present invention can also be seen according to a variant of the processes in that the filling of the damping agent chamber is carried out directly in a damping agent bath. The outer sleeve is logically also pushed onto the elastomeric bearing body in the damping agent liquid. The filling of the damping agent chambers can thus be carried out under the liquid surface without inclusions of air, which guarantees an end product of high quality.

Since the liquid contained in the volumes has a viscosity different from that of the damping liquid contained in the damping agent chambers, the volume should be cleaned before filling with the viscous liquid to avoid contaminations or chemical reactions and premature aging of the viscous liquid which may possibly be associated therewith. The cleaning may be carried out, for example, by means of a rinsing operation or by admitting compressed air.

Corresponding to a continuation of the inventive idea, it is meaningful to carry out the filling of the volume in a liquid bath. The advantages that arise were already explained before.

The processes according to the present invention are also applicable to hydraulic bearings provided with volumes on both ends. The volumes are filled alternatingly in this case, i.e., the damping agent chambers are first filled with the damping agent after the inner part with the elastomeric bearing body vulcanized to it as well as the outer sleeve have been prefabricated. The outer sleeve is first pushed onto the elastomeric bearing body only up to the axially inner sealing lip, i.e., the sealing lip facing the damping agent chamber for the subsequently filling of the first volume with the viscous liquid. After the first volume has been filled with the viscous liquid, the outer sleeve is pushed beyond the elastomeric bearing body and the first volume to the extent that the second volume is exposed on the axially opposite side of the hydraulic bushing and this second volume can thus be filled. The outer sleeve is then pushed back over the elastomeric bearing body until the outer sleeve also contacts the second, axially outer sealing lip in a sealing manner.

Calibration, carried out after the mounting of the hydraulic bearing, i.e., the reduction of the outer circumference of the outer sleeve at least in some sections, has considerable advantages especially in the process according to the present invention.

The pressure in the volumes filled with the viscous liquid can be specifically adapted now to the ambient pressure or it may be higher than this, but it may at least be higher than the pressure of the damping agent in the damping agent chambers.

To achieve reliable sealing action by the viscoseals, the hydraulic bearing according to the present invention is preferably designed such that the liquid in the viscoseals has an overpressure compared to the ambient pressure. The pressure is applied in the course of the manufacture of the bearing during the calibration thereof via the walls defining these volumes and is preferably set such that it is reliably higher than the highest conceivable ambient pressure. The increase in the pressure in the viscoseals, which is brought about with the calibration, develops because of the incompressibility of the liquid in the corresponding volumes. It shall be noted here that even in the case of hydraulic bearings whose damping agent chambers have no vacuum compared to the environment, there is improved sealing action in the embodiment according to the present invention with viscoseals, for example, in respect to the penetration of air, especially when the pressure of the liquid in the viscoseals is above the ambient pressure.

Corresponding to a practical embodiment, ethylene glycol is used as the viscous liquid for achieving the damping action. Various possibilities, which also depend, last but not least, on the particular application, can be considered for the geometric design of the viscoseals, i.e., of the volumes accommodating the viscous liquid. Thus, it is conceivable to design corresponding viscoseals by channel grooves extending completely circularly at both axial ends of a hydraulic bearing designed as a bush bearing. However, it is also possible to interrupt such a groove at points at which sealing action is not necessary, e.g., in the area of a load-bearing support that may be present. The viscoseals have a segmented design in this case.

A hydraulic bearing according to the present invention, which can be manufactured according to one of the processes described, may have the peculiarity that there is a flow-conducting connection between at least two of its volumes. Corresponding to an embodiment of this idea, it is possible, moreover, that all volumes of the hydraulic bearing have a flow-conducting connection between each other.

The present invention shall be explained in greater detail below on the basis of an exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an axial sectional detail cut away view of a hydraulic bearing according to a first process step of a first process according to the present invention;

FIG. 2 is an axial sectional detail cut away view of a hydraulic bearing according to a second process step according to the present invention;

FIG. 3 is an axial sectional detail cut away view of a hydraulic bearing according to a third process step according to the present invention;

FIG. 4 is an axial sectional detail cut away view of a completely mounted hydraulic bearing according to the present invention;

FIG. 5 is an axial sectional detail cut away view of a hydraulic bearing corresponding to a second process according to the present invention;

FIG. 6 is a schematic side view showing the connection between damping agent chambers as well as the interconnection of end volumes of a hydraulic bearing according to the present invention; and

FIG. 7 is a schematic sectional view taken at line 7-7 of FIG. 6.

### DESCRIPTION OF THE PREFERRED EMBODIMENTS

Referring to the drawings in particular, the hydraulic bearing shown in the figures comprises an inner part 1 made of a metal or plastic, an elastomeric bearing body 2 connected to the inner part 1 by vulcanization, and an outer sleeve 3, which accommodates the inner part 1 with the bearing body 2 and is tubular in this example. The outer sleeve 3 may likewise be manufactured from a metal or plastic.

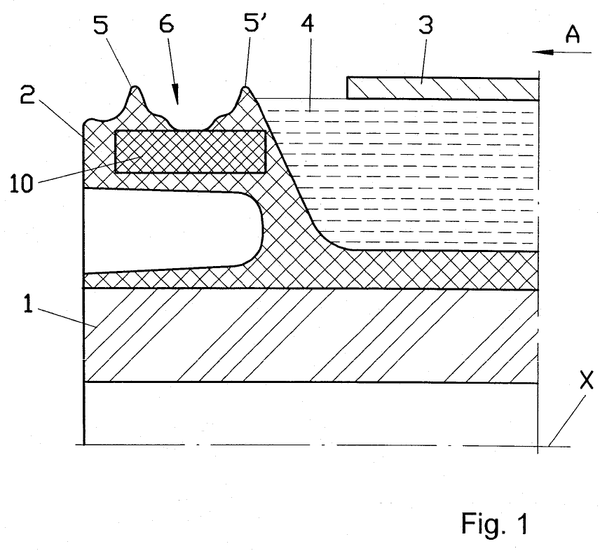

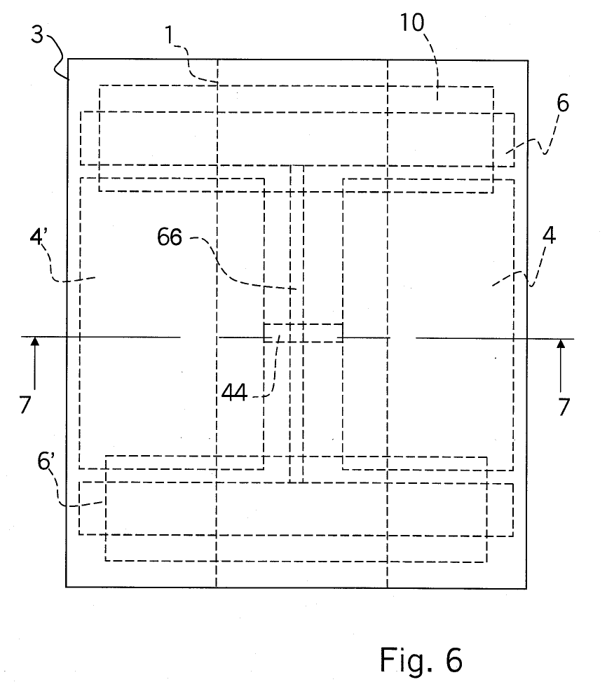

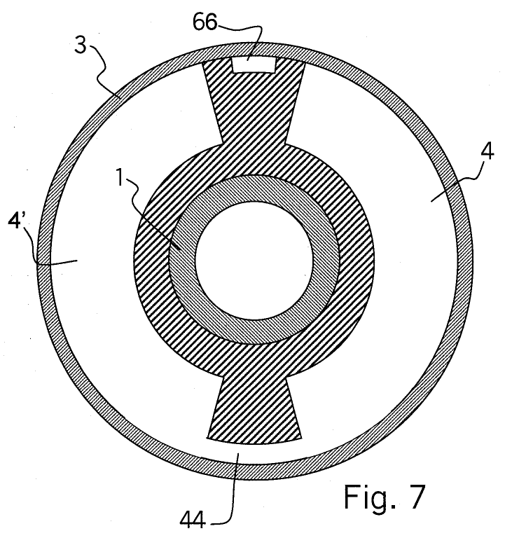

Two damping agent chambers 4, 4′, which are filled with a viscous damping agent and are connected to one another through an overflow channel or throttle channel 44 (shown in FIGS. 6 and 7), are formed in the bearing body 2, only one axial half of the body, which is rotationally symmetrical with the axis X, being shown in FIGS. 1-5. FIGS. 1-5 fail to show that the hydraulic bearing has the same design on both sides, i.e., it is mirror symmetrical with a plane extending at right angles to the central longitudinal axis X.

In the area of the front-side end of the bearing, the elastomeric bearing body 2, which is designed as a rubber spring here, has a section with an enlarged outside diameter. The outside diameter of the bearing body 2 is made with an oversize compared to the internal diameter of the outer sleeve 3. Due to the outer sleeve 3 being pushed onto the bearing body 2 and the optional subsequent calibration, i.e., the reduction of the diameter of the outer sleeve 3, especially at the axial ends of the bearing body, a pretension is generated, so that these areas act as a sealing lip 5 or 5′. The bearing is reliably sealed as a result against the escape of the viscous liquid present in the damping agent chambers 4, 4′. The volume 6 (as well as volume 6′) present between the sealing lips 5, 5′ has no flow-conducting connection with the damping agent chambers 4, 4′. This volume 6 is either a circular (ring shaped) channel, not to be confused with the throttle channel 44, or a channel groove or chambers, which are formed in some sections along the circumference of the hydraulic bearing, whose volume is usually, but not necessarily, smaller than that of the damping agent chambers 4, 4′ provided for generating the damping action of the bearing.

Moreover, a reinforcing insert 10, which stabilizes the elastomer, is embedded in the elastomeric bearing body 2 at each of the axial ends of the bearing.

The inner part 1 and the outer sleeve 3 are first manufactured separately in the process according to the present invention for manufacturing a hydraulic bearing. The elastomeric bearing body 2 is subsequently connected to the inner part 1, which is possible by means of a vulcanization process in a manner known per se. The components of the hydraulic bearing, thus prefabricated, are subsequently introduced into a bath containing damping liquid, in which the outer sleeve 3 is pushed on in the direction of arrow A shown in FIG. 1 under the liquid level.

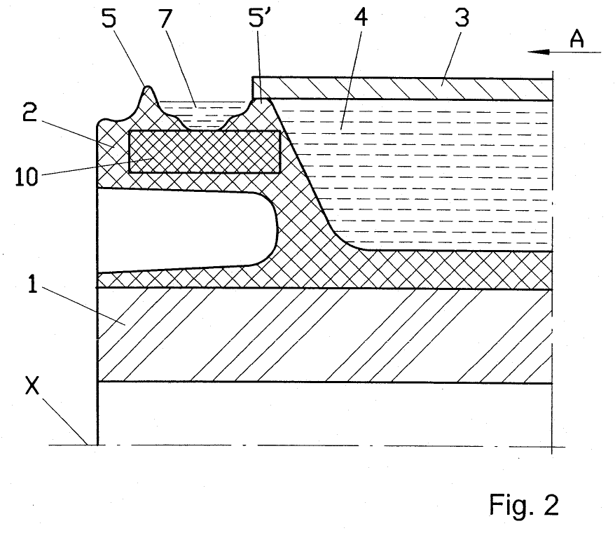

As is shown in FIG. 2, the outer sleeve 3 is pushed on only up to the inner sealing lip 5′, i.e., the sealing lip facing the damping agent chamber 4. The assembly unit thus assembled is removed from the damping agent bath and at least the area of the volume 6 formed between the sealing lips 5 and 5′ is cleaned, which is possible with a rinsing agent suitable for this. After cleaning, the entire hydraulic bearing can be immersed into a bath of the viscous liquid 7, which is enclosed in the volume 6 after the finishing of the hydraulic bearing and has a viscosity that is higher than the viscosity of the damping agent. A simplified view of the volume 6 filled with the viscous liquid 7 is likewise visible in FIG. 2.

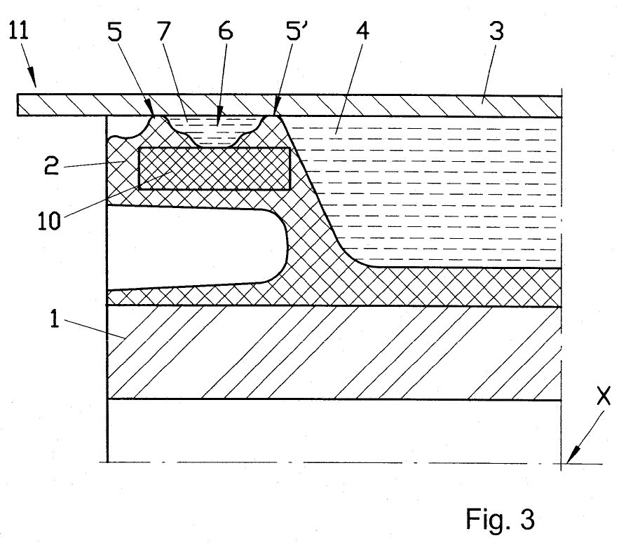

As is shown in FIG. 3, the outer sleeve 3 is pushed in the next process step beyond the axial end of the hydraulic bearing to the extent that a projection 11 of the outer sleeve 3 is formed, whose length corresponds to the distance of the sealing lips 5 and 5′ on the axially opposite side of the left-hand part of the hydraulic bearing shown in FIG. 3. Thus, the other end of the outer sleeve 3, which is not shown in FIG. 3, is sealingly in contact with the inner sealing lip 5′ present there, as this was already explained in the reverse direction in connection with the view in FIG. 2. The second volume 6′ can thus likewise be filled with the liquid 7.

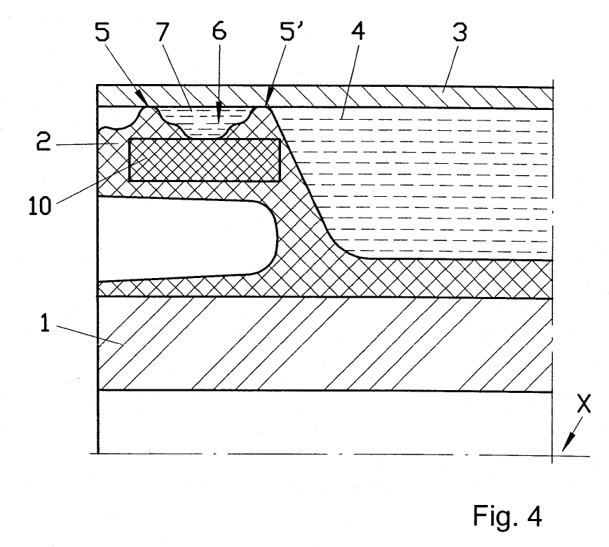

Finally, the hydraulic bearing is finished by displacing the outer sleeve 3 relative to the central longitudinal axis X in the direction opposite that indicated by arrow A, whereby flush closure of the front sides of the elastomeric bearing elements 2 and of the outer sleeve 3 is achieved. The completely mounted hydraulic bearing is shown in FIG. 4 in a sectional view.

Regardless of the pressure in the damping agent chambers 4, 4′, a quantity of viscous liquid 7, by which a pressure, preferably an overpressure, is generated in relation to the ambient pressure via the outer walls because of its incompressibility in the course of the pushing on and the subsequent calibration (reduction of the diameter) of the outer sleeve 3, is introduced into the additional volumes 6, 6. Since the sealing action of the sealing lips 5, 5′ against the viscous damping agent is sufficient in any case, the damping agent does not escape from the volumes 6, 6′ either to the outside or into the damping agent chambers 4, 4′. At the same time, the pressure prevailing in the volumes 6, 6′ reliably prevents air from penetrating into the bearing and the damping agent chambers 4, 4′ of the bearing, which may optionally be under a vacuum.

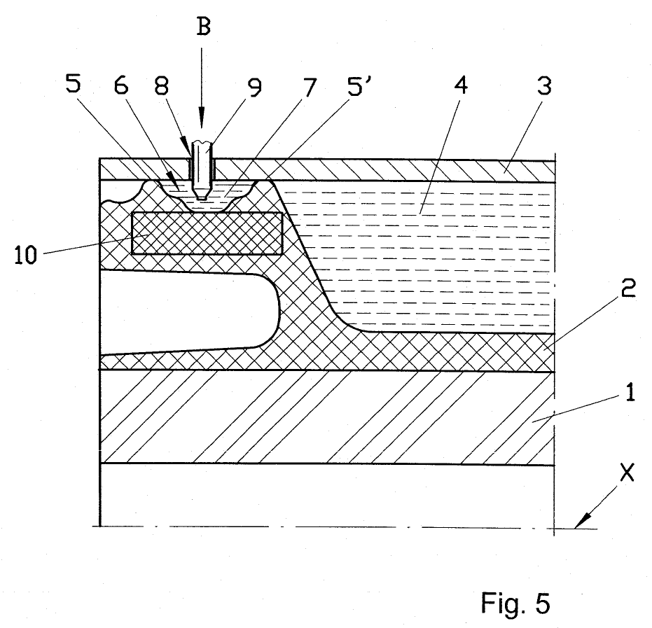

The hydraulic bearing illustrated in FIG. 5 has basically a design identical to the above-described design. The same process steps as those described before are also observed in this hydraulic bearing though the step of the filling of the damping agent chambers 4, 4′.

The volumes 6, 6′ are cleaned and the outer sleeve 3 is subsequently pushed completely onto the elastomeric bearing body 2 after the filling of the damping agent chambers 4, 4′. The viscous liquid 7 can now be introduced into the volume 6 by means of an injection nozzle 9. A filling opening 8, through which the injection nozzle 9 is passed into the volume 6, is provided in the outer sleeve 3 for this purpose. After filling the volume 6 with the liquid 7 in the direction of arrow B in FIG. 5, the injection nozzle 9 is removed from the filling opening against the direction of arrow B. This operation is concluded by a subsequent sealing of volume 6 against the environment.

The schematic showing of FIG. 6 illustrates the basically symmetrical design of the sealing (additional) volumes 6 and 6′ at each end and the damping agent chambers 4, 4′, that are on each side. FIGS. 6 and 7 also illustrate the flow-conducting connection 66 between the two volumes 6 and 6′. The flow-conducting connection 66 may be provided between an outer part of the elastomeric bearing body 2 (provided in a groove or recess of the elastomeric bearing body 2) and the inner surface of the adjacent to the outer sleeve 3 and between the damping agent chambers 4, 4′, but opposite the throttle channel 44.

While specific embodiments of the invention have been shown and described in detail to illustrate the application of the principles of the invention, it will be understood that the invention may be embodied otherwise without departing from such principles.

What is claimed is:

1. A process for manufacturing a hydraulic bearing, the process comprising:
providing an inner part;
connecting an elastomeric bearing body to said inner part by vulcanization with the elastomeric bearing body surrounding said inner part;
providing an outer sleeve which accommodates said inner part with said bearing body, wherein at least two damping agent chambers are provided inwardly of said outer sleeve and are connected to one another through a flow or throttle channel;
providing said elastomeric bearing body with two sealing lips to seal said at least two damping agent chambers against the escape of the damping agent and to provide a volume between an axially inner sealing lip and an axially outer sealing lip of said sealing lips, said volume not being connected to said damping agent chambers in a flow-conducting manner and said volume being arranged separated from said damping agent chambers and from said channel connecting same;
filling said damping agent chambers with damping agent;
subsequent to filling, pushing said outer sleeve onto the hydraulic bearing and over said elastomeric bearing body only up to said axially inner sealing lip;
subsequent to pushing, filling said volume with a viscous liquid having a viscosity that differs from a viscosity of said damping agent; and
subsequent to filling said volume, pushing said outer sleeve completely over said elastomeric bearing body.

2. A process in accordance with claim 1, wherein said filling of said damping agent chamber is carried out in a damping agent bath.

3. A process in accordance with claim 1, wherein said volume is cleaned before filling with said viscous liquid.

4. A process in accordance with claim 1, wherein said volume is filled in a liquid bath.

5. A process in accordance with claim 1, wherein said elastomeric bearing body is provided with plural sets of two sealing lips providing plural volumes with at least one volume on one bearing side and another volume on another bearing side that are filled alternatingly on both sides.

6. A process in accordance with claim 1, wherein said outer sleeve is calibrated by reducing an outer circumference thereof at least in some sections, wherein said outer sleeve is calibrated after a mounting of said outer sleeve on said elastomeric bearing body of the hydraulic bearing.

7. A process for manufacturing a hydraulic bearing, the process comprising:
providing an inner part;
connecting an elastomeric bearing body to said inner part by vulcanization with the elastomeric bearing body surrounding said inner part;
providing an outer sleeve which accommodates said inner part with said bearing body, wherein at least two damping agent chambers are provided inwardly of said outer sleeve and are connected to one another through a flow or throttle channel;
providing said elastomeric bearing body with two sealing lips, to seal said at least two damping agent chambers against the escape of the damping agent, and to provide a volume between an axially inner sealing lip and an axially outer sealing lip of said sealing lips, said volume not being connected to said damping agent chambers in a flow-conducting manner and said volume being arranged separated from said damping agent chambers and from said channel connecting same;
filling said damping agent chambers with damping agent;
subsequent to said filling with damping agent, pushing said outer sleeve onto said elastomeric bearing body of the hydraulic bushing; and
subsequent to said pushing, filling of said volume, through a filling opening in said outer sleeve, with a viscous liquid having a viscosity that differs from a viscosity of said damping agent.

8. A process in accordance with claim 7, wherein said filling of said damping agent chamber is carried out in a damping agent bath.

9. A process in accordance with claim 7, wherein said volume is cleaned before filling with said viscous liquid.

10. A process in accordance with claim 7, wherein said volume is filled in a liquid bath.

11. A process in accordance with claim 7, wherein said elastomeric bearing body is provided with plural sets of two sealing lips providing plural volumes with at least one volume on one bearing side and another volume on another bearing side that are filled alternatingly on both sides.

12. A process in accordance with claim 7, wherein said outer sleeve is calibrated by reducing an outer circumference thereof at least in some sections, wherein said outer sleeve is calibrated after mounting of said outer sleeve on said elastomeric bearing body of the hydraulic bearing.

13. A process in accordance with claim 7, wherein said volume is filled by means of an injection nozzle.

14. A hydraulic bearing, manufactured by a process comprising:
providing an inner part;
connecting an elastomeric bearing body to said inner part by vulcanization with the elastomeric bearing body surrounding said inner part;
providing an outer sleeve which accommodates said inner part with said bearing body, wherein at least two damping agent chambers are provided inwardly of said outer sleeve and are connected to one another through a flow or throttle channel;
providing said elastomeric bearing body with two sealing lips to seal said at least two damping agent chambers against the escape of the damping agent and to provide a volume between an axially inner sealing lip and an axially outer sealing lip of said sealing lips, said volume not being connected to said damping agent chambers in a flow-conducting manner and said volume being arranged separated from said damping agent chambers and from said channel connecting same;
filling said damping agent chambers with damping agent;
subsequent to said filling with damping agent, pushing said outer sleeve onto said elastomeric bearing body of the hydraulic bushing; and
filling said volume with a viscous liquid having a viscosity that differs from a viscosity of said damping agent wherein there is a flow-conducting connection between at least two said volumes of the hydraulic bearing.

15. A hydraulic bearing in accordance with claim 14, wherein all said volumes of said hydraulic bearing have a flow-conducting connection with one another.
